(19) United States
(12) Patent Application Publication
(10) Pub. No.: US 2011/0113593 A1
(43) Pub. Date: May 19, 2011

(54) Self reversing caster

(75) Inventor: Charles P. Bebbington, Doylestown, PA (US)

(73) Assignee: John Bean Technologies Corporation, Chicago, IL (US)

(21) Appl. No.: 12/590,757

(22) Filed: Nov. 13, 2009

(51) Int. Cl. B60B 33/00

(52) U.S. Cl. 16/45

(57) ABSTRACT

A caster assembly includes a swivel assembly having a pivot axis, a housing which is connected to the swivel assembly, and a wheel which is slidably supported for linear movement along the longitudinal axis of the housing. The wheel is slidable along the longitudinal axis to move the rotational axis of the wheel from one side of the pivot axis to the other.

### BACKGROUND OF THE INVENTION

The present invention relates to casters. More particularly, the invention relates to a caster assembly which comprises a wheel that is slidably supported in a housing such that the wheel can reverse its direction of trail without having to swing through an arc about the pivot axis of the housing.

Casters are commonly used as support wheels on a variety of vehicles. Swivel casters are usually non-powered wheels which are designed to pivot about a vertical axis to enable the vehicles to turn within a relatively tight radius. Swivel casters typically include a wheel which is supported in a yoke that in turn is connected to a swivel assembly to enable the yoke to pivot about a vertical axis. The axle of the wheel is normally offset from the pivot axis of the yoke. Thus, as the vehicle travels in a particular direction, the caster wheel will “trail” the pivot axis. The horizontal distance between the axle of the wheel and the pivot axis of the yoke is often referred to as “caster trail”.

When the caster reverses direction, the offset between the axle of the wheel and the pivot axis of the yoke forces the wheel to swing through an arc having a radius which is equal to the caster trail. On vehicles with at least a single caster, this swing can result in a noticeable sideways movement of the vehicle, which is commonly known as “caster kick.” On vehicles with multiple casters, it is not uncommon for the casters to swing in opposite directions, which can result in a condition known as “caster lock”. In this case, a greatly increased force is required to reverse the trail of the caster.

### SUMMARY OF THE INVENTION

In accordance with the present invention, these and other limitations in the prior art are addressed by providing a caster assembly which includes a swivel assembly which comprises a pivot axis; a housing which is connected to the swivel assembly, the housing comprising a longitudinal axis which is generally perpendicular to the pivot axis; and a wheel which is slidably supported by the housing for linear movement along the longitudinal axis, the wheel comprising a rotational axis which is generally perpendicular to the longitudinal axis. Thus, the wheel is slidable along the longitudinal axis to move the rotational axis from one side of the pivot axis to the other.

In accordance with one embodiment of the invention, the wheel is rotationally connected to a yoke which is slidably supported in the housing.

In accordance with another embodiment of the invention, the caster assembly further comprises a slide assembly which is positioned between the housing and the yoke. In this embodiment, the housing may comprise a top plate which is connected to the swivel assembly and the slide assembly may be positioned between the top plate and the yoke.

In accordance with yet another embodiment of the invention, the yoke comprises a pair of lateral arms and the slide assembly comprises a pair of first and second bearing devices, each of which is positioned between the top plate and a corresponding arm.

In accordance with still another embodiment of the invention, the housing comprises a pair of lateral support rails and the slide assembly comprises a pair of third and fourth bearing devices, each of which is positioned between an arm and a corresponding support rail.

Each of the first and second bearing devices may comprise an inner race which is connected to a corresponding arm and an outer race which is positioned against the housing. In addition, the length of the inner races may be approximately equal to the length of the arms and the length of the outer races may be approximately equal to the length of the housing.

In accordance with a further embodiment of the invention, the swivel assembly comprises a kingpin which is connected to the housing and a bearing assembly which is positioned concentrically around the kingpin. Also, the swivel assembly may comprise a mounting plate which is connected to the kingpin on a side of the bearing assembly opposite the housing.

Thus, instead of forcing the wheel to swing through an arc about the pivot axis in order to change the direction of trail, the caster assembly of the present invention allows the wheel to simply move axially from one side of the pivot axis to the other. Such motion greatly minimizes the possibility of caster kick and caster lock occurring as the vehicle reverses direction.

These and other objects and advantages of the present invention will be made apparent from the following detailed description, with reference to the accompanying drawings. In the drawings, the same reference numbers may be used to denote similar components in the various embodiments.

### BRIEF DESCRIPTION OF THE DRAWINGS

FIG. 1 is a side view of a representative vehicle which includes the caster assembly of the present invention;

FIG. 2 is a perspective view of the caster assembly shown in FIG. 1;

FIG. 3 is a partially exploded, transverse cross sectional view of the caster assembly of the present invention taken along line 3-3 of FIG. 2; and

FIG. 4 is a longitudinal cross sectional view of the caster assembly of the present invention taken along line 4-4 of FIG. 3.

### DETAILED DESCRIPTION OF THE INVENTION

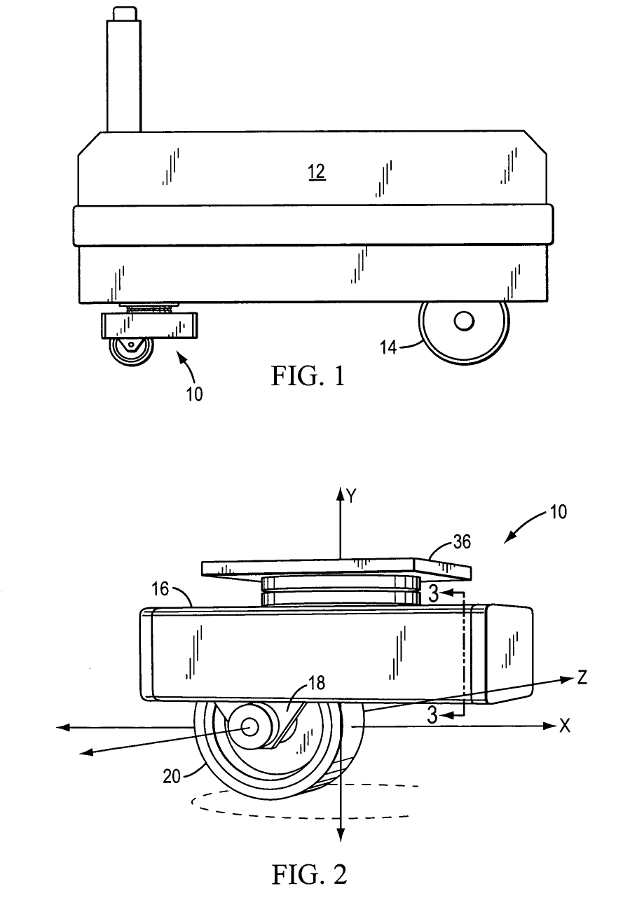

Referring to FIG. 1, the caster assembly of the present invention, generally 10, is shown mounted to a representative vehicle, such as an automatic guided vehicle (“AGV”) 12. In the illustrative embodiment of the invention shown, the AGV 12 includes a single caster assembly 10 which is mounted under the rear of the vehicle and two conventional wheel assemblies 14 (only one of which is visible) which are mounted under the front of the vehicle. Although the caster assembly 10 is described herein in conjunction with the AGV 12, it should be understood that the invention may be used with a variety of vehicles or devices which are designed to roll on a support surface.

Referring to FIG. 2, the caster assembly 10 of one exemplary embodiment of the invention includes a wheel support housing 16 which is rotationally connected to the vehicle 12, a yoke 18 which is slidably supported in the housing, and a wheel 20 which is rotationally supported in the yoke. The housing 16 is rotatable relative to the vehicle 12 about a generally vertical pivot axis Y, and the yoke 18 is slidable relative to the housing along a generally horizontal longitudinal axis X. In addition, the wheel 20 is rotatable relative to the yoke 18 about a horizontal rotational axis Z which is essentially perpendicular to the longitudinal axis X. Thus, as the vehicle 12 reverses direction, the wheel 20 will move axially relative to the housing 16 from one side of the pivot axis Y to the other.

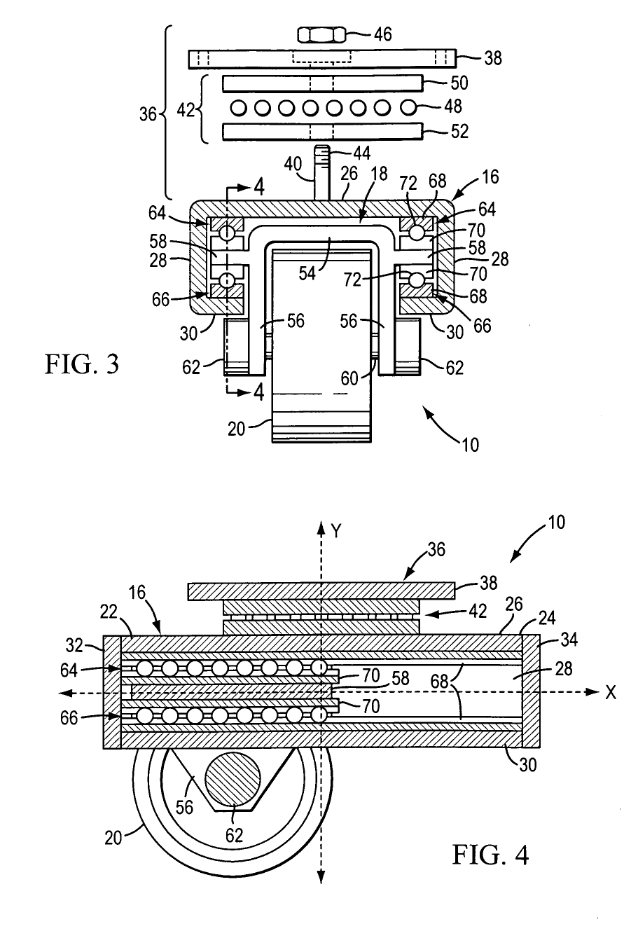

Referring to FIGS. 3 and 4, the wheel support housing 16 comprises a first end 22, a second end 24, a generally horizontal top plate 26 which extends longitudinally between the first and second ends, a pair of side plates 28 which each extend downwardly from a corresponding side of the top plate, and a pair of support rails 30 which each extend laterally inwardly from a corresponding side plate. The top plate 26, the side plates 28 and the support rails 30 may be constructed as a unit from a single piece of material. The wheel support housing 16 may also comprise first and second end plates 32, 34 which are respectively connected such as by welding to the first and second ends 22, 24.

The housing 16 is pivotally connected to the vehicle 12 by a swivel assembly 36. The swivel assembly 36 may include, for example, a mounting plate 38 which is bolted or otherwise suitably connected to the vehicle 12, a kingpin 40 which is welded or otherwise suitably connected to the top plate 26 approximately mid way between the first and second ends 22, 24, and a bearing assembly 42 which is positioned over the kingpin between the mounting plate and the top plate. In this example, the kingpin 40 includes a threaded end 44 which extends through a corresponding hole in the mounting plate 38, and the swivel assembly 36 includes a nut 46 which is attached to the threaded end to thereby secure the swivel assembly to the top plate 26.

The bearing assembly 42 may comprise, for example, a plurality of balls 48 which are positioned between an upper race 50 and a lower race 52, although any suitable thrust-type bearing assembly may be used instead. The bearing assembly 42 is positioned coaxially around the kingpin 40 so that, in the embodiment of the invention shown in FIGS. 3 and 4, the kingpin defines the vertical axis Y around which the housing 16 rotates.

The yoke 18 includes a generally horizontal base 54, two generally vertical legs 56 which each extend downwardly from a corresponding side of the base, and a pair of arms 58 which each extend laterally outwardly from a corresponding leg. The wheel 20 is mounted on an axle 60 whose ends are secured to the legs 56 by appropriate means, such as a pair of lugs 62. The axle 60 thus defines the rotational axis Z around which the wheel 20 rotates.

The yoke 18 is slidably supported in the housing 16 by a suitable slide assembly. In the exemplary embodiment of the invention shown in FIGS. 3 and 4, for example, the slide assembly includes two linear slide-type bearing devices 64, each of which is positioned between a corresponding arm 58 and the top plate 26 of the housing 16. The bearing devices 64 transfer the weight of the vehicle 12 from the housing 16 to the yoke 18, which in turn transfers the weight to the wheel 20. The slide assembly may also comprise two additional bearing devices 66 to help slidably secure the yoke 18 within the housing 16. Each bearing device 66 is positioned between an arm 58 and a corresponding support rail 30 of the housing 16.

Each bearing device 64, 66 includes an outer race 68 which is positioned against the housing 16, an inner race 70 which is connected to a corresponding arm 58, and a plurality of balls 72 which are positioned between the upper and lower races. In addition, the length of the outer races 68 is ideally approximately the same as the length of the housing 16, and the length of the inner races 70 is roughly the same as length of the arms 58. Thus, the arms 58 are able to slide relative to the housing 16 from one side of the pivot axis Y to the other. In this regard, the end plates 32, 34 act as stops to prevent the inner races 70 from sliding beyond the outer races 58.

In accordance with the present invention, as the vehicle 12 travels in a particular direction, the wheel 20 will trail the pivot axis Y, that is, the rotational axis Z will be located on one side of the pivot axis. When the vehicle 12 reverses direction, the wheel 20 will slide relative to the housing 16 until the rotational axis Z is located on the opposite side of the pivot axis Y so that the wheel will once again trail the pivot axis. Thus, the invention allows the wheel 20 to move axially from one side of the pivot axis Y to the other in order to reverse the direction of trail. This obviates the need for the wheel 20 to swing through an arc about the pivot axis Y as the vehicle changes direction and thereby minimizes or eliminates caster kick and caster lock.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

What is claimed is:

1. A caster assembly which includes:
a swivel assembly which comprises a pivot axis;
a housing which is connected to the swivel assembly, the housing comprising a longitudinal axis which is generally perpendicular to the pivot axis; and
a wheel which is slidably supported by the housing for linear movement along the longitudinal axis, the wheel comprising a rotational axis which is generally perpendicular to the longitudinal axis;
wherein the wheel is slidable along the longitudinal axis to move the rotational axis from one side of the pivot axis to the other.

2. The caster assembly of claim 1, wherein the wheel is rotationally connected to a yoke which is slidably supported in the housing.

3. The caster assembly of claim 2, further comprising a slide assembly which is positioned between the housing and the yoke.

4. The caster assembly of claim 3, wherein the housing comprises a top plate which is connected to the swivel assembly and the slide assembly is positioned between the top plate and the yoke.

5. The caster assembly of claim 4, wherein the yoke comprises a pair of lateral arms and the slide assembly comprises a pair of first and second bearing devices, each of which is positioned between the top plate and a corresponding arm.

6. The caster assembly of claim 5, wherein the housing comprises a pair of lateral support rails and the slide assembly comprises a pair of third and fourth bearing devices, each of which is positioned between an arm and a corresponding support rail.

7. The caster assembly of claim 5, wherein each of the first and second bearing devices comprises an inner race which is connected to a corresponding arm and an outer race which is positioned against the housing.

8. The caster assembly of claim 7, wherein the length of the inner races is approximately equal to the length of the arms and the length of the outer races is approximately equal to the length of the housing.

9. The caster assembly of claim 1, wherein the swivel assembly comprises a kingpin which is connected to the housing and a bearing assembly which is positioned concentrically around the kingpin.

10. The caster assembly of claim 9, wherein the swivel assembly comprises a mounting plate which is connected to the kingpin on a side of the bearing assembly opposite the housing.

11. A caster assembly for a vehicle which comprises:
a housing which is pivotally connectable to the vehicle about a pivot axis, the housing comprising a longitudinal axis which is generally perpendicular to the pivot axis; and
a wheel which is slidably supported by the housing for linear movement along the longitudinal axis, the wheel comprising a rotational axis which is generally perpendicular to the longitudinal axis;
wherein the wheel is slidable along the longitudinal axis to move the rotational axis from one side of the pivot axis to the other as the vehicle reverses its direction of travel.

12. The caster assembly of claim 11, wherein the wheel is rotationally connected to a yoke which is slidably supported in the housing.

13. The caster assembly of claim 12, further comprising a slide assembly which is positioned between the housing and the yoke.

14. The caster assembly of claim 13, wherein the housing comprises a top plate which is connected to the swivel assembly and the slide assembly is positioned between the top plate and the yoke.

15. The caster assembly of claim 14, wherein the yoke comprises a pair of lateral arms and the slide assembly comprises a pair of first and second bearing devices, each of which is positioned between the top plate and a corresponding arm.

16. The caster assembly of claim 15, wherein the housing comprises a pair of lateral support rails and the slide assembly comprises a pair of third and fourth bearing devices, each of which is positioned between an arm and a corresponding support rail.

17. The caster assembly of claim 15, wherein each of the first and second bearing devices comprises an inner race which is connected to a corresponding arm and an outer race which is positioned against the housing.

18. The caster assembly of claim 17, wherein the length of the inner races is approximately equal to the length of the arms and the length of the outer races is approximately equal to the length of the housing.

19. The caster assembly of claim 11, wherein the housing is connected to the vehicle by a swivel assembly.

20. The caster assembly of claim 19, wherein the swivel assembly comprises a mounting plate which is connected to the vehicle, a kingpin which is connected to the housing, and a bearing assembly which is positioned concentrically around the kingpin between the mounting plate and the housing.
